(19) United States
(12) Patent Application Publication
(10) Pub. No.: US 2014/0140295 A1
(43) Pub. Date: May 22, 2014

(54) Apparatus and Method for Proactive Inter-Cell Interference Coordination

(71) Applicant: Jawad Manssour, Seoul (KR)

(72) Inventor: Jawad Manssour, Seoul (KR)

(73) Assignee: TELEFONAKTIEBOLAGET L M ERICSSON (PUBL), Stockholm (SE)

(21) Appl. No.: 14/130,777

(22) PCT Filed: Apr. 12, 2012
(86) PCT No.: PCT/SE2012/050398

§ 371 Date: Jan. 3, 2014

Related U.S. Application Data
(60) Provisional application No. 61/507,346, filed on Jul. 13, 2011.

(51) Int. Cl. H04L 5/00; H04W 72/12

(52) U.S. Cl. CPC H04L 5/0032; H04W 72/1205
USPC 370/329

(57) ABSTRACT

A network node (10) communicates with user equipments, UEs, in a cell served by the network node. The network node receives measurement reports from, scheduled UEs (S1) and determines, based on the measurement reports, a number of neighboring cells that scheduled future transmissions by the scheduled UEs are likely to interfere with (S2). An interference indicator for each of the number of neighboring cells likely to be interfered with is determined (S3), and the network node sends the interference indicator to one or more neighbor network nodes serving one of the number of neighboring cells likely to be interfered with (S4).

### BACKGROUND

The technology pertains to wireless communications networks, and particularly, to coordinating inter-cell interference between cells.

In a typical cellular radio system, radio or wireless terminals (also known as mobile stations and/or user equipment units (UEs)) communicate via a radio access network (RAN) to one or more core networks. The radio access network (RAN) covers a geographical area which is divided into cell areas, with each cell area being served by a base station, e.g., a radio base station (RBS), which in some networks may also be called, for example, a “NodeB” (UMTS) or “eNodeB” (LTE). A cell is a geographical area where radio coverage is provided by the radio base station equipment at a base station site. Each cell is identified by an identity within the local radio area, which is broadcast in the cell. The base stations communicate over the air interface operating on radio frequencies with the user equipment units (UEs) within range of the base stations. in some radio access networks, several base stations may be connected (e.g., by landlines or microwave) to a radio network controller (RNC) or a base station controller (BSC). The radio network controller supervises and coordinates various activities of the plural base stations connected thereto. The radio network controllers are typically connected to one or more core networks.

Although 3GPP terminologies pertaining to LTE are used in the following for explanation purposes, this should not be seen as limiting the scope of the disclosed subject matter to only a particular 3GPP system like LTE. Other wireless systems, such as WCDMA, UMTS, WiMax, UMB, GSM and others may benefit from exploiting the ideas cowered within this disclosure.

Modern and future wireless systems are expected to support bandwidth-hungry and high bit rate-demanding applications with even stricter requirements on throughput and quality of service (QoS). These expectations have motivated the use of multiple antennas at the transmitter and/or receiver side, more advanced receivers and receiving algorithms, and smarter radio resource management (RRM) techniques. The result has been an increase the system's throughput and capacity by manifolds, especially in the downlink.

Because the evolved Node B (eNB) in LTE (a radio base station) typically has more processing and transmit power as compared to a user equipment (UE) radio terminal (referred to simply as a UE), the uplink communication from UE to eNB is a more difficult challenge for researchers and system designers, especially in terms of “cell-edge throughput.” Enhanced uplink cell-edge performance means improved end-user experience, especially given increases in both quantity and required QoS for uplink traffic.

FIG. 1 illustrates a common uplink cell-edge interference scenario. The uplink transmission of UE2 in the right cell served by eNB2 is interfering with the uplink transmission from UE1 to its serving eNB1.

One way of enhancing the uplink performance is through RRM. From a high level perspective, RRM-related schemes affecting the uplink performance may be divided in two groups. The first is fast RRM including link adaptation, power control, and scheduling. Fast RRM techniques operate on a transmission time interval (TTI) basis, i.e., they take decisions every millisecond. The second is slow RRM that includes inter-cell interference coordination (ICIC) schemes. Slow RRM techniques operate on a slower time scale (e.g., 20 milliseconds or longer) because they require exchanging information between different eNBs stations over the X2 interface in LTE. In X2-based ICIC, the coordination may occur between cells belonging to different eNBs and between cells belonging to the same eNB.

An ICIC scheme may include Fractional Frequency Reuse (FFR) which is now explained with reference to FIG. 2. In FFR, UEs classified as high-interfering UEs (HIU) may be scheduled only on a specific part of the radio frequency spectrum referred to as a high interference region (HIR). FIG. 2 illustrates the FFR concept with a special example case of non-overlapping HIRs between three cells. In FIG. 2, the size of the HIRs are equal and the HIRs are not overlapping. This is mainly for the purpose of illustration. However, ICIC schemes are expected to control the size of the HIRs and whether they are allowed to overlap in specific cells. HIUs in cell 1 may only be scheduled over HIR1, but non-HIUs may be scheduled to transmit using radio resources anywhere in the spectrum, including in the HIR. By avoiding scheduling cell-edge UEs on the same part of the spectrum in neighboring cells, inter-cell interference experienced by the cell-edge UEs is expected to significantly decrease, leading to an increase in the Signal to Interference Ratio (SINR) experienced by these cell-edge UEs.

An ICIC scheme, and in particular X2-based ICIC, endeavors to dynamically coordinate the allocation of these HIRs between different cells without the need for manual cell planning, while taking into account the traffic change in different cells over time. In performing X2-based ICIC, the 3GPP standard supports two parameters: a high interference indicator (HII) and an interference overload indicator (IOI). The HII indicates the occurrence of high interference sensitivity on specific physical resource blocks (PRB) (e.g., the eNB will schedule cell edge UEs transmitting with maximum power) using a bitmap (0's and 1's) and is sent to one or several specific cells. As such, HII is a proactive parameter indicating that high interference will occur on a particular PRB, and HII may be used so that a cell informs other cells which HIR the cell is using. The IOI indicates the interference level (high, medium, or low) experienced by the cell on specific PRBs. Given that a cell does not know where the interference it is suffering of comes from, the cell sends the IOI to neighboring cells. In other words, the IOI is a reactive parameter used by a cell to inform other cells whether that cell is experiencing high interference. But a desirable goal is a proactive approach to ICIC.

One of the main challenges in applying a proactive approach to ICIC is the decentralized architecture in many modern wireless systems such as LTE, WiMax, etc. This decentralization makes it challenging for a certain radio network node like an eNB to know which cell(s) to cooperate with. A particular challenge for a proactive approach to ICIC is that a certain cell typically does not know to which neighboring cells it should send a HII. It is desirable to transmit this HII information only to concerned cells in order to avoid triggering unnecessary action at cells that will not suffer from interference resulting from future scheduled UE transmissions in the certain cell.

A manual cell planning approach to ICIC is proactive in some sense, but it is expensive for operators and suboptimal because it does not take into account traffic dynamics, i.e., the movement and location of users in a certain cell. Just because two cells are geographically close does not mean that their respective UE transmissions will cause uplink (UL) interference to each other. For example, one of the cells may not have UEs on the border with the neighboring cell scheduled to transmit.

Furthermore, the HII measure supported by 3GPP is a bitmap that includes zeros and ones that simply indicate the absence or occurrence (a hard measure) of high interference on specific PRBs. It is desirable for proactive ICIC technology to provide a softer interference indicator measure that allows more freedom/options at the cells receiving a certain HII as to how they should interpret these HII measures.

For proactive ICIC, a cell needs to intelligently and dynamically select which cells it should coordinate with and send its HII to. Furthermore, these coordinating cells need to know how much they should react to this HII.

The technology in this application solves these and other problems.

### SUMMARY

A first aspect of the technology includes a network node for interference coordination in a wireless communications network, the network node communicating with user equipments (UEs) in a cell served by the network node. The network node includes a communication unit configured to receive measurement reports from scheduled UEs as well as a determination unit. The determination unit is configured to determine, based on the received measurement reports, a number of neighboring cells that scheduled future transmissions by the scheduled UEs are likely to interfere with, and to determine an interference indicator for each of the number of neighboring cells likely to be interfered with. The communications unit is further configured to send the interference indicator to one or more neighbor network nodes serving one of the number of neighboring cells likely to be interfered with.

A second aspect of the technology includes a method for interference coordination in a wireless communications network including a network node communicating with user equipments (UEs) in a cell served by the network node. The method includes the network node performing the following steps comprising: receiving measurement reports from scheduled UEs; determining, based on the measurement reports, a number of neighboring cells that scheduled future transmissions by the scheduled UEs are likely to interfere with; determining an interference indicator for each of the number of neighboring cells likely to be interfered with; and sending the interference indicator to one or more neighbor network nodes serving one of the number of neighboring cells likely to be interfered with.

A third aspect of the technology includes a serving radio network node for a radio communications network communicates over a radio interface with user equipment (UE) radio terminals located in a first cell served by the serving radio network node. The serving radio network node may be for example a radio base station, a NodeB, an eNB, a home base station, a relay, or a repeater. The first cell is in range of multiple neighboring cells, and each of the neighboring cells is served by a neighboring radio network node. Radio circuitry in the serving node receives UE measurement information from UEs that it serves and that are scheduled to transmit over the radio interface. One example way to obtain the measurement information is to use one or more predetermined handover measurement events to trigger measurement reports that may be used to gauge to inter-cell interference. Another example is that such measurements may be ordered or triggered by the network node.

The serving node includes electronic circuitry that determines, based on the received UE measurement information, a number of neighboring cells that scheduled future transmissions by the served UEs are likely to interfere with. It generates interference indicator information for the number of neighboring cells likely to be interfered with. Network communications circuitry in the node sends the generated interference indicator information to one or more neighbor radio network nodes serving one of the neighboring cells likely to be interfered with. One example way to do this is to send the interference measurement information in an inter-cell interference coordination message.

In accordance with one non-limiting and example implementation, the interference indicator information includes an estimate associated with an amount or a degree of interference likely to be caused in the number of neighboring cells by the served UE scheduled future transmissions. The interference indicator information includes or is sent along with information for identifying uplink radio resources scheduled to be used by one or more of the served UE scheduled transmissions. By only sending the generated interference indicator information to a subset of the number of neighboring cells likely to be interfered with unnecessary signaling and processing is avoided. For example, the amount or degree of interference likely to be caused in the number of neighboring cells by the served UE scheduled transmissions may be compared to a predetermined threshold and the generated interference indicator information is then not sent to neighboring cells whose amount or degree of interference is less than the predetermined threshold.

In another non-limiting and example implementation, the serving node selectively weights the interference indicator information differently for different one of the neighbor cells. For one example implementation, the interference indicator information is a standardized information element that conveys the same information to each one of the neighboring cells to which the network communication circuitry sends the interference indicator information. A weight associated with the standardized information element sent to one of the neighbor cells may be increased by repeating a cell identifier within that standardized information element. Another example implementation increases the weight associated with the standardized information element for a neighbor cell by repeating the standardized information element sent to that neighbor cell.

A fourth aspect of the technology relates to one of the neighboring radio network nodes associated with a neighboring cell that neighbors the serving cell associated with the serving radio network node. The neighboring node receives interference indicator information from the serving radio network node and determines, based on the received interference indicator information, an estimate of interference or an interference event likely to be experienced in the neighboring cell as a result of scheduled future transmissions by UEs served by the serving radio network node. From that, it determines whether to account for the received interference indicator information in scheduling radio resources for future communications with UEs served by the neighboring node. As mentioned above, one example way for the neighboring node to receive the interference measurement information is via an inter-cell interference coordination message.

The neighboring radio network node may include in one example implementation an uplink transmission scheduler. If the neighboring node determines that the interference indicator information indicates a level of likely uplink interference as a result of future scheduled transmissions by UEs served by the serving radio network node, e.g., the level exceeds a predetermined threshold, then the uplink transmission scheduler schedules future communications with UEs served by the neighboring radio network node to avoid or reduce the impact of the likely uplink interference.

In an example implementation, the received interference indicator information includes an estimate associated with an amount or degree of interference likely to be caused in the neighboring cell by the scheduled future transmissions. The received interference indicator information may include or be received along with information for identifying uplink radio resources to be used by scheduled future transmissions by UEs served by the serving radio network node.

As another example implementation, the received interference indicator information is weighted differently for different neighbor cells, and the neighboring node then determines a weight associated with the received interference indicator information and whether and how to account for the received interference indicator information in scheduling radio resources for future communications with UEs served by the neighboring radio network node based on the determined weight.

A further example implementation uses a standardized information element to convey the same interference indicator information to multiple neighboring cells. A higher weight may be determined for the received standardized information element based on a higher number of repetitions of a cell identifier corresponding to the neighboring cell included in the received standardized information element.

Another example alternative implementation is to determine a higher weight for the received standardized information element based on a higher number of repetitions of the standardized information element received by the network communications circuitry. A counter counts a number of standardized information elements received in a first time interval started after receiving a first of the standardized information elements. A second time interval is then preferably waited after accounting for the number of standardized information elements received in the first time interval in scheduling radio resources for future communications before counting subsequently received standardized information elements.

The technology described above provides multiple advantages. For example, the technology dynamically identifies which cells should coordinate with each other with regard to likely inter-cell interference. This selectivity reduces the amount of inter-cell signaling and reduces the number of cells that need to take some type of ameliorative action. In turn, the chances of having a “ripple effect” in the system where all or a large number of cells send inter-cell information to each other, forcing them all to take unnecessary processing and possibly unnecessary ameliorative action.

Another advantage is the technology permits weighting of an existing HII measure from a serving cell to several neighbor cells and to communicate this weighting in a way that is compatible with current 3GPP standards.

The technology avoids the need for manual planning for high interference regions (HIRs) by dynamically selecting the HIR via coordination between different cells, e.g., by choosing HIR with a lowest sum weight, etc. In other words, not all geographically neighboring cells will uplink interfere with each other.

### BRIEF DESCRIPTION OF THE DRAWINGS

FIG. 1 illustrates a common uplink cell-edge interference scenario;

FIG. 2 illustrates a bandwidth scheduling for high interference region (HIR) parts of the radio spectrum;

FIG. 3 is a non-limiting example function block diagram of an LTE cellular communications network;

FIG. 4 is a non-limiting example for configuring Event A3 UE measurement reporting events for interference measurements;

FIG. 5 is an example diagram showing multiple neighboring cells with cell border UEs in cell A;

FIG. 6 is a flowchart illustrating non-limiting, example procedures for a network node in accordance with a first example embodiment;

FIG. 7 is non-limiting example function block diagram of a network node in accordance with the example first embodiment;

FIG. 8 is a flowchart illustrating non-limiting, example procedures for a serving radio network node in accordance with an example second embodiment;

FIG. 9 is a flowchart illustrating non-limiting, example procedures for a neighboring radio network node in accordance with the example second embodiment; and

FIG. 10 is non-limiting example function block diagram of a radio network node in accordance with the example second embodiment.

### DETAILED DESCRIPTION

In the following description, for purposes of explanation and not limitation, specific details are set forth such as particular architectures, interfaces, techniques, etc. However, it will be apparent to those skilled in the art that the technology described here may be practiced in other embodiments that depart from these specific details. That is, those skilled in the art will be able to devise various arrangements which, although not explicitly described or shown herein, embody the principles of the technology described and are included within its spirit and scope. In some instances, detailed descriptions of well-known devices, circuits, and methods are omitted so as not to obscure the description with unnecessary detail. All statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein may represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled or described as “computer”, “processor” or “controller” may be provided through the use of dedicated hardware as well as hardware capable of executing software in the form of coded instructions stored on computer readable medium. A computer is generally understood to comprise one or more processors and/or controllers, and the terms computer and processor may be employed interchangeably herein. When provided by a computer or processor, the functions may be provided by a single dedicated computer or processor, by a single shared computer or processor, or by a plurality of individual computers or processors, some of which may be shared or distributed. Such functions are to be understood as being computer-implemented and thus machine-implemented. Moreover, use of the term “processor” or “controller” shall also be construed to refer to other hardware capable of performing such functions and/or executing software, and may include, without limitation, digital signal processor (DSP) hardware, reduced instruction set processor, hardware (e.g., digital or analog) circuitry, and (where appropriate) state machines capable of performing such functions.

The technology described below addresses and resolves issues described in the background. Each base station (cell) dynamically determines which neighboring cell(s) its served UEs will interfere with for scheduled UE transmissions and the likelihood (e.g., expressed as a percentage or probability) that its UEs will actually interfere with those scheduled transmissions. This information may be based, for example, on long-term measures that take into account the speed of the ICIC process. Based on the likelihood of interference, the base station (cell) sends interference indicator information to one or more neighbor cells to inform the one or more neighbor cells a likelihood of suffering from interference caused by the scheduled UE transmissions. This informs the one or more neighbor cells how to coordinate scheduling of its own UE transmissions to avoid or decrease experiencing inter-cell interference. For example, the one or more neighbor cells may avoid scheduling a HIU on PRBs with a high likelihood of scheduled interference. In one example embodiment, a certain cell may communicate weighted HII measures to different neighbor cells.

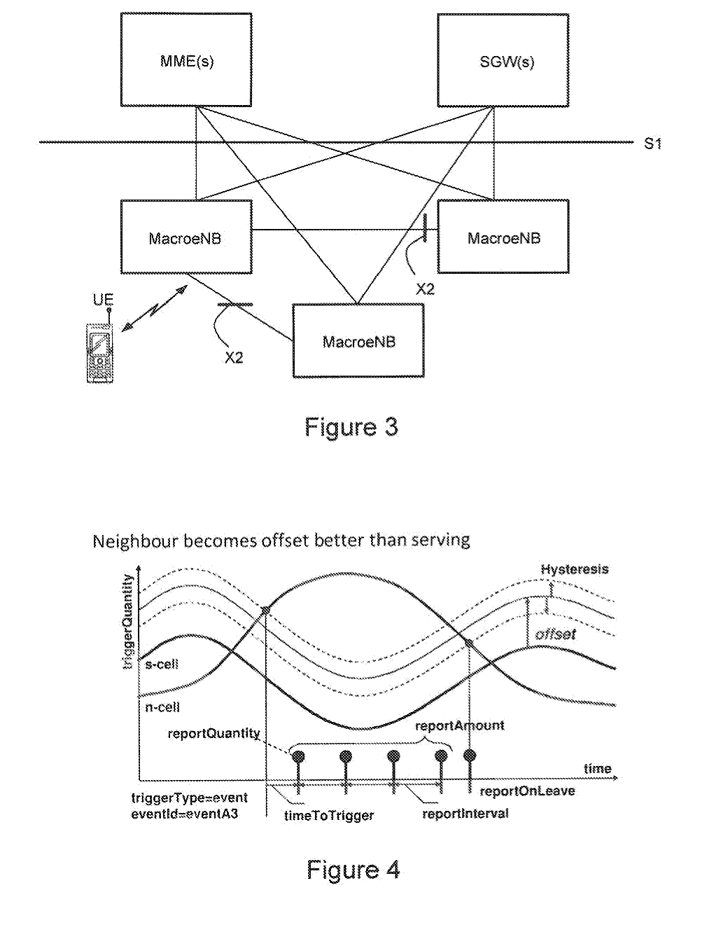

Although the technology may be used in any radio access network (RAN), single-RAT or multi-RAT, for illustration purposes 3GFP LTE examples are provided. In this regard, FIG. 3 shows an example diagram of an LTE-based communications system. The core network nodes include one or more Mobility Management Entities MMEs), a key control node for the LTE access network, and one or more Serving Gateways (SGWs) which route and forward user data packets while and acting as a mobility anchor. They communicate with base stations, referred to in LTE as eNBs, over an S1 interface. The eNBs may include macro and micro eNBs that communicate over an X2 interface. The term “cell” is used below to describe both a geographic radio coverage area and an eNB entity that provides radio access network service in that area. The cells serve and communicate with one or more UEs over the radio interface.

In a decentralized system without a central node coordinating decisions, it is advantageous for a cell to selectively determine the appropriate neighbor cells to coordinate with. In other words, a cell may determine that it should coordinate with only some subset of its neighbor cells. In particular, when sending interference indicator measurement information to a neighboring cell, a cell preferably specifies those cells for which this measurement is intended. In the following non-limiting description, which is in an example LTE context, the LTE HII measurement is used as an example of interference indicator measurement information. This selectivity reduces the number of receiving nodes (eNBs) that need to receive the HII signaling, thereby reducing X2 signaling across the X2 interface and ensuring that neighbor cells avoid taking unnecessary interference avoidance actions. Such unnecessary actions could otherwise lead to a “ripple effect” in the network, i.e., a ping-pong effect where one unnecessary action based on coordination leads to another unnecessary action.

Initially, a cell obtains interference measurements from its UEs. It may then use these measurements in order to obtain statistics and/or other information about the neighbor cells that uplink UE transmissions that the cell has scheduled will interfere with. One example way to obtain interference measurements from its UEs is using one or more existing handover events. Consider for example the existing handover measurement triggering event A3 shown in FIG. 4. A new ICIC-based A3 event for the purpose of interference measurements does not result in changes to the triggering event shown in FIG. 4. Preferably but not necessarily, an ICIC-based A3 event has a more aggressive configuration as compared to a handover-based A3 event, e.g., the ICIC-based event is triggered earlier than the handover-based event in order to start coordinating UEs before they reach the handover phase. The parameters that may be configured include e.g. the time to trigger (TTT), offset and hysteresis. Each cell may obtain measurements from its served (e.g., RRC-connected) UEs identifying those cell(s) the UE uplink measurements are likely to interfere with the most. By properly setting the A3 event threshold, the serving cell may control what level of interference is considered as sufficiently high interference. One way to keep track of this is for the serving cell to maintain a list in memory of the cells its served UEs will likely interfere with the most.

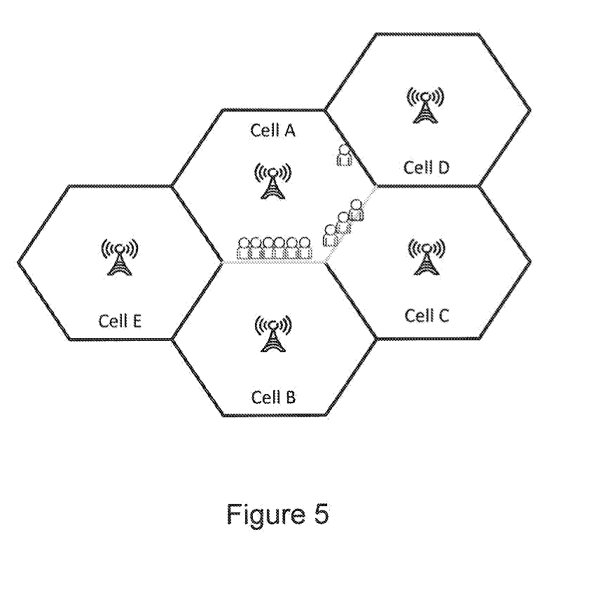

Consider Cell A in the example illustrated in FIG. 5. Cell A is currently serving ten cell-edge UEs corresponding to ten high-interfering UEs (HIUs). Six of these HIUs are likely to create high uplink (UL) interference at cell B, three HIUs are likely to create high UL interference at cell C, and one HIU is likely to create high UL interference at cell D. Assume that cell A has scheduled all of these cell-edge UEs for an equal number of physical resource blocks (PRBs), which is quite plausible because cell-edge UEs become power limited, and as such, may only use a limited number of PRBs. Alternatively, cell A may use statistics about the number of PRBs that some UEs have been allocated for scheduled uplink transmissions, and possibly also take into account each of the UE's transmit buffer size to have sense of how much data is to be sent, to determine a likelihood of how much those scheduled UE transmissions will interfere with cells B, C, and D. In this example, those respective likelihoods are 60%, 30%, and 10%. The percentage may be related to the level of resource utilization and time and/or frequency. Statistics may be based for example on previous decisions, or by using average values of path loss and interference estimation.

From the UE measurements, the serving cell A may determine two important characteristics. First, cell A dynamically determines which neighboring cells its scheduled UEs are likely to interfere with, and thus, to which neighbor cells cell A should send a high interference indicator (HII). Second, cell A may determine statistically which neighboring cells its scheduled UEs will likely interfere with more than others. This allows cell A to inform the neighboring cells likely to be disturbed (1) that they will he disturbed, (2) when that disturbance will occur, and (3) how much they should take into account the HII they receive from cell A, e.g., a weighted HII.

Based on the situation described above for FIG. 5, cell A knows that its scheduled UEs will likely interfere with cells B, C, and D, and to which extent those scheduled transmissions will interfere with them. For instance, cell A may determine that because the scheduled transmissions will only interfere at a 10% level with cell D, cell A will not send an HII to cell D to avoid the HII signaling and to avoid triggering cell D from taking action to mitigate the inter-cell interference from cell A.

A non-limiting example implementation allows a serving cell to communicate different weighted values of an HII it sends to different cells. This may be implemented for example using either the same information element (IE) or a repetition of the same IE. Recall that the HII in LTE is a bitmap send to selected neighbor cells. In this example, each receiving neighbor cell extracts the same information from the HII. But as seen from the example above in FIG. 5, UEs in one cell often cause more interference to some neighbor cells as compared to other neighbor cells. One example way to convey different information in the context of the same HII sent to different neighbor cells is to employ weighting.

As one example implementation, in the HII information element (IE), the identifier (ID) of each neighbor cell is used to effectively weight the HII information. For instance, if serving cell A wants to convey to neighbor cell B that its scheduled UEs will likely cause interference and/or the power of such interference is high, cell A may repeat the ID of cell B several times inside the same IE. More cell ID repetitions, the more severe the likely expected interference from cell A's UEs. For example, if cell A repeats the cell ID of cell B three times, cell B may interpret this as cell A's scheduled UEs will likely create high interference in cell B. On the other hand, cell A may include the ID of cell C only once in the HII IE to indicate that cell A's scheduled UEs will create interference to in cell C with a smaller likelihood.

As another example implementation, cell A sends the same HII IE (with each cell ID included only once) multiple times to cell B depending on the severity of the likely interference. Repeated HII IEs may be sent consecutively so that a neighbor cell knows that if it receives several HII IEs within a predetermined time interval from the same sending cell, then the sending cell is informing the neighbor cell of a weight factor to be applied to the repeated HII IEs. Accordingly, the neighbor cell may use a a fixed timer or time interval that is triggered after the reception of the first information element (IE). Within this timer, all sent IEs from the same cell are considered to be used for weighting purposes. We may further assume another timer that is used for stability, i.e. once a cell takes action based on some received IE(s), it will not react to any received IEs until this timer elapses to ensure enough time for convergence and avoiding a ping-pong effect.

Consider the following non-limiting example of how neighboring cells B-D receiving the HII IE from the serving cell A may use it. Each cell receiving the HII adds up the number of received HIIs. If cell B receives three copies of HII=111000000 (or if it has its cell ID used 3 times in the same HII IE), cell B calculates a weighted HII of 333000000. Cell B may also add this weighted HII sum to HII IEs it receives from other neighbor cells to generate a total likely interference value. From that total likely interference value, cell B may determine its own high interference region (HIR) on the physical resource blocks (PRBs) that have the smallest total likely interference value. Individual PRBs may have different HII sums, but it may also be the case that a cell may be configured to have an HIR that is as contiguous as possible.

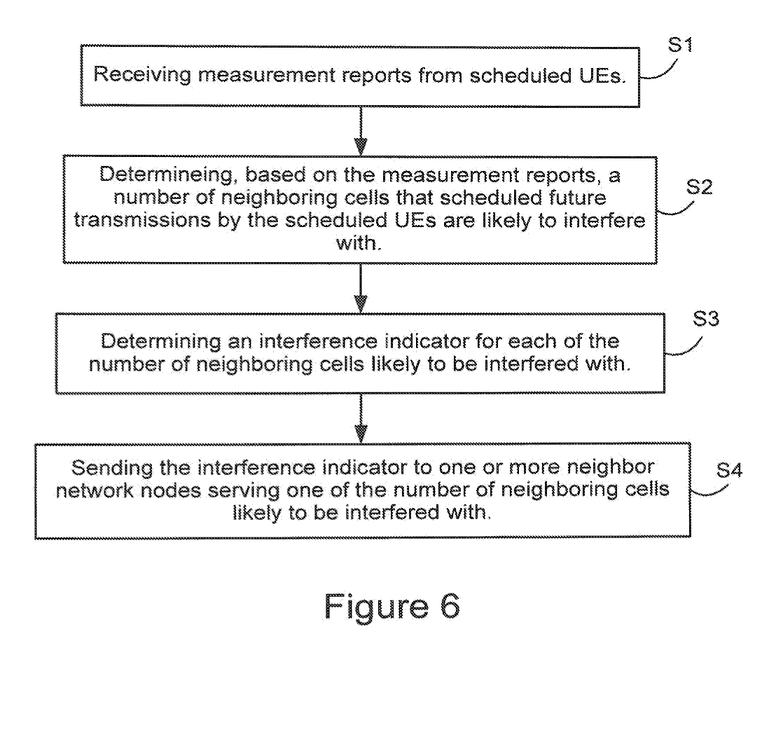

FIG. 6 is a flowchart illustrating non-limiting, example procedures for a network node in accordance with a first example embodiment. Initially, the network node receives measurement reports from scheduled UEs (step S1). Based on the measurement reports, the network node determines a number of neighboring cells that scheduled future transmissions by the scheduled UEs are likely to interfere with (step S2). The node determines an interference indicator for each of the number of neighboring cells likely to be interfered with (step S3). Then, the network node sends the interference indicator to one or more neighbor network nodes serving one of the neighboring cells likely to be interfered with (step S4).

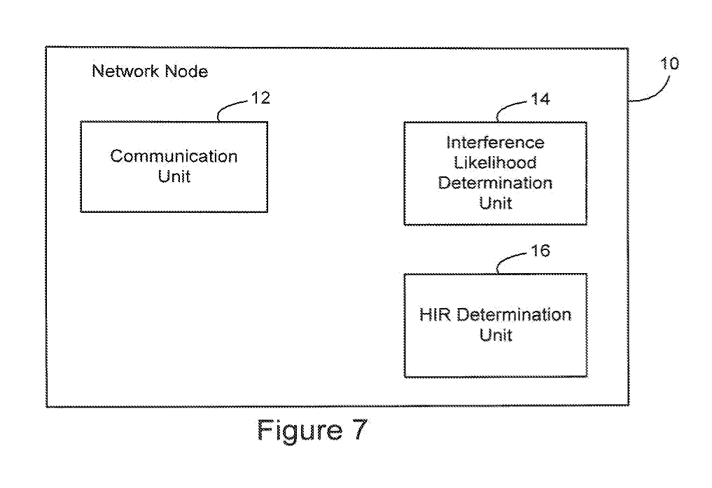

FIG. 7 is non-limiting example function block diagram of a network node 10 in accordance with the example first embodiment. The network node 10 may include a communication unit 12, an interference likelihood determination unit 14, and a HIR determination unit 16. The communication unit 12 may communicate with UEs over wireless channels, for example, to receive measurement reports. The communication Unit 12 may also communicate with other similar network nodes 10 including other cells over the X2 interface for example to exchange HII information.

Based on the measurement reports, the interference likelihood determination unit 14 may determine which neighboring cells may be interfered with by the cell and/or its UEs, and may also determine the probability or likelihood that interference will actually occur for each of the neighboring cells. The HIR determination unit 16 may determine or choose its HIR based on the HII information received from other cells.

FIG. 7 provides a logical view of the network node and the units included therein. It is not strictly necessary that each unit be implemented as physically separate modules. Some or all units may be combined in a physical module. Also, the units need not be implemented strictly in hardware, it is envisioned that the units may be implemented through a combination of hardware and software. For example, the network node may include one or more central processing units executing program instructions stored in a non-transitory storage medium or in firmware to perform the functions of the units.

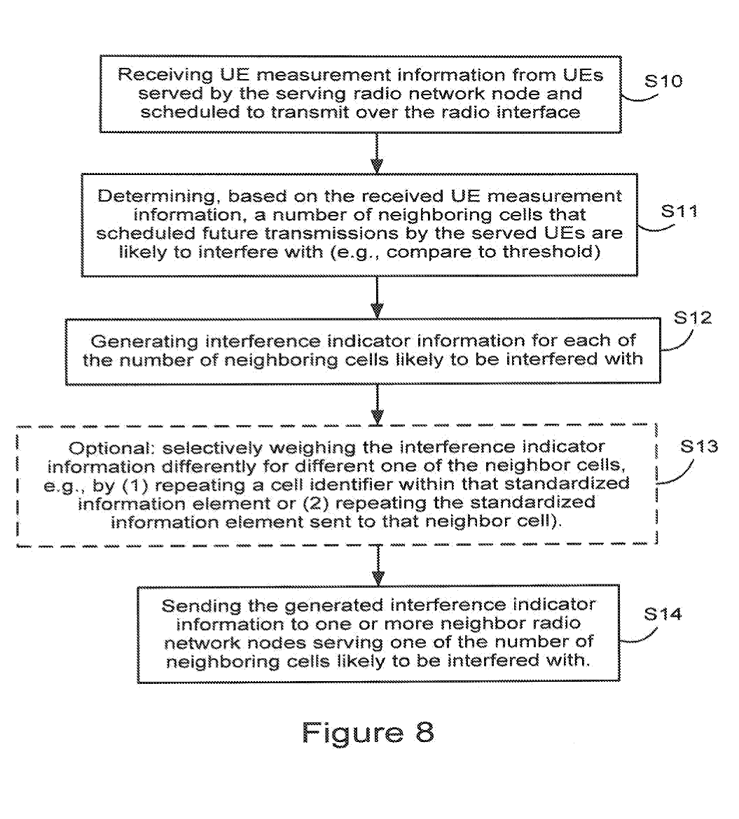

FIG. 8 is a flowchart illustrating non-limiting, example procedures for a serving radio network node in accordance with a second example embodiment. Initially, the serving radio network node receives UE measurement information from UEs served by the serving radio network node and scheduled to transmit over the radio interface (step S10). The serving node determines, based on the received UE measurement information, a number of neighboring cells that scheduled future transmissions by the served UEs are likely to interfere with e.g., by comparing to threshold (step S11). Interference indicator information is generated for each of the number of neighboring cells likely to be interfered with (step S12). One optional step (step S13 shown as a dashed box) selectively weights the interference indicator information differently for different one of the neighbor cells, e.g., by (1) repeating a cell identifier within that standardized information element or (2) repeating the standardized information element sent to that neighbor cell). The serving node sends the generated interference indicator information to one or more neighbor radio network nodes serving one of the number of neighboring cells likely to be interfered with (step S14).

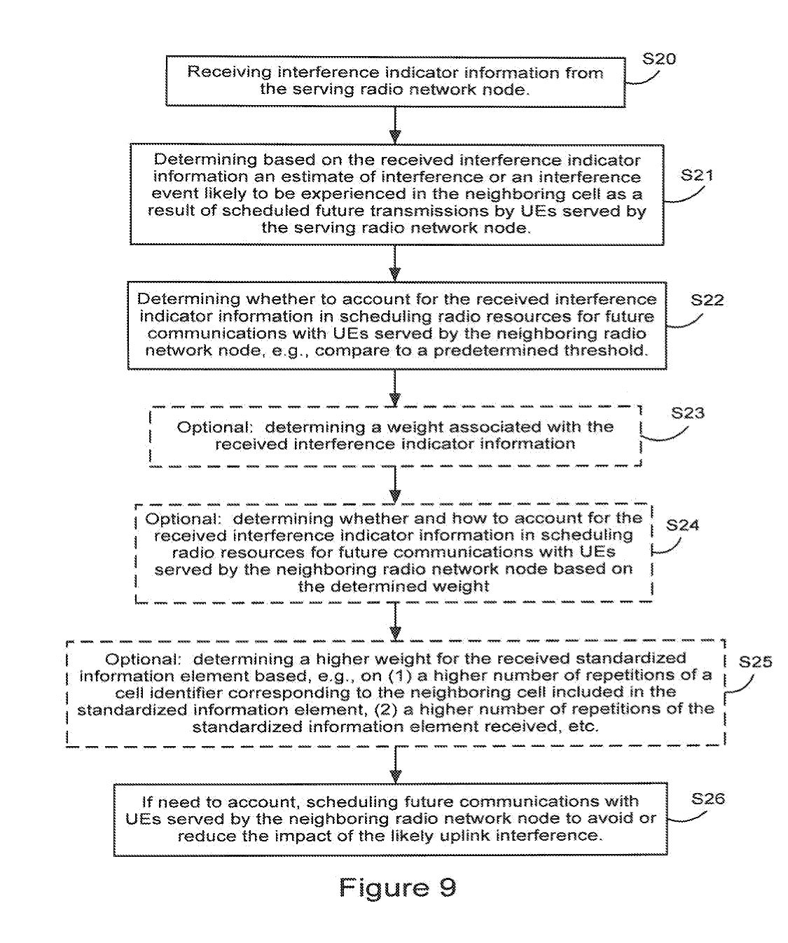

FIG. 9 is a flowchart illustrating non-limiting, example procedures for a neighboring radio network node in accordance with the second example embodiment. The neighboring node receives interference indicator information from the serving radio network node (step S20) and determines, based on the received interference indicator information, an estimate of interference or an interference event likely to be experienced in the neighboring cell as a result of scheduled future transmissions by UEs served by the serving radio network node (step S21). The neighboring node may then determine whether to account for the received interference indicator information in scheduling radio resources for future communications with UEs served by the neighboring radio network node, e.g., compare to a predetermined threshold (step S22). As described in examples above, the neighboring radio network node may perform one or more optional steps. For example, it may determine a weight associated with the received interference indicator information (step S23) and/or determine whether and how to account for the received interference indicator information in scheduling radio resources for future communications with UEs served by the neighboring radio network node based on the determined weight (step S24). As another optional step, the neighboring node may determine a higher weight for the received standardized information element based, e.g., on (1) a higher number of repetitions of a cell identifier corresponding to the neighboring cell included in the standardized information element, (2) a higher number of repetitions of the standardized information element received, etc. (step S25). Ultimately, if the neighboring node decides that it needs to account for the received interference indicator information, it schedules future communications with UEs served by the neighboring radio network node to avoid or reduce the impact of the likely uplink interference (step S26).

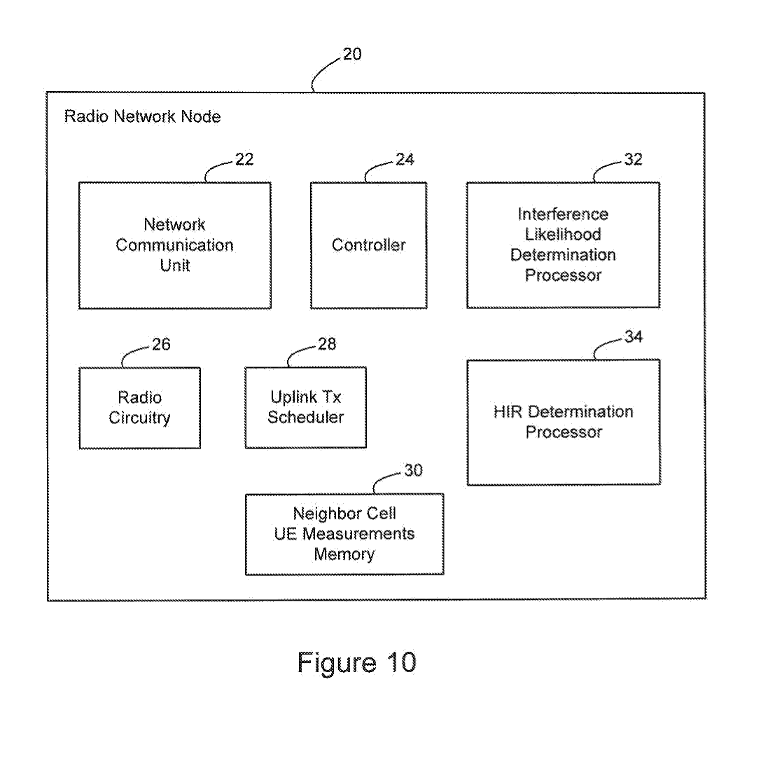

The methods described in FIGS. 8 and 9 may be implemented by a radio network node on behalf of a cell. An example radio network node 10 is illustrated in FIG. 10 in accordance with the second example embodiment. The node 20 includes a network communications unit 22 that allows the node to send and receive information with neighboring radio network nodes and other network nodes. Radio circuitry 26 includes radio transmitter and radio receiver circuitry for conducting radio communications with UEs over the air using one or more suitable radio access technologies (RATs). An uplink transmission scheduler 28 coordinates the scheduling of uplink transmissions by UEs being served by node 20. The node includes one or more memories for storing instructions and data. Some of that data includes neighbor cell UE measurements received in accordance with suitable triggering points, e.g., see Event A3 in FIG. 4, which are then stored in neighbor cell UE measurement memory 30. An interference likelihood determination processor 32 is configured to (1) determine a number of neighboring cells that scheduled future transmissions by the served UEs are likely to interfere with based on the UE measurement information stored in memory 30 and (2) generate interference indicator information, e.g., an HII, for the number of neighboring cells likely to be interfered with. The interference likelihood determination processor 32 may also selectively weight the interference indicator information differently for different one of the neighbor cells as described above. The interference likelihood determination processor 32 sends the interference indicator information to neighboring nodes via the network communications unit 22 and via the X2 interface in LTE. The HIR determination processor 34 may determine or choose its high interference region (HIR) based on the HII information received from other cells via the network communication unit 22. A controller 24 supervises and coordinates the operations in the radio network node 20.

So based on the measurement reports, the interference likelihood determination processor 32 is configured to determine which neighboring cells may be interfered with by the cell and/or its UEs, and may also determine the probability likelihood that interference will actually occur for each of the neighboring cells.

Again, FIG. 10 provides a logical view of the network node 10 and processors, units, memory, and circuitry included, therein. It is not necessary that each be implemented as physically separate modules. Some or all blocks may be combined in a physical module. Also, the functions described need not be implemented strictly in hardware but may also be implemented through a combination of hardware and software. For example, the radio network node 20 may include one or more central processing units executing program instructions stored in a non-transitory storage medium or in firmware to perform the functions of the units.

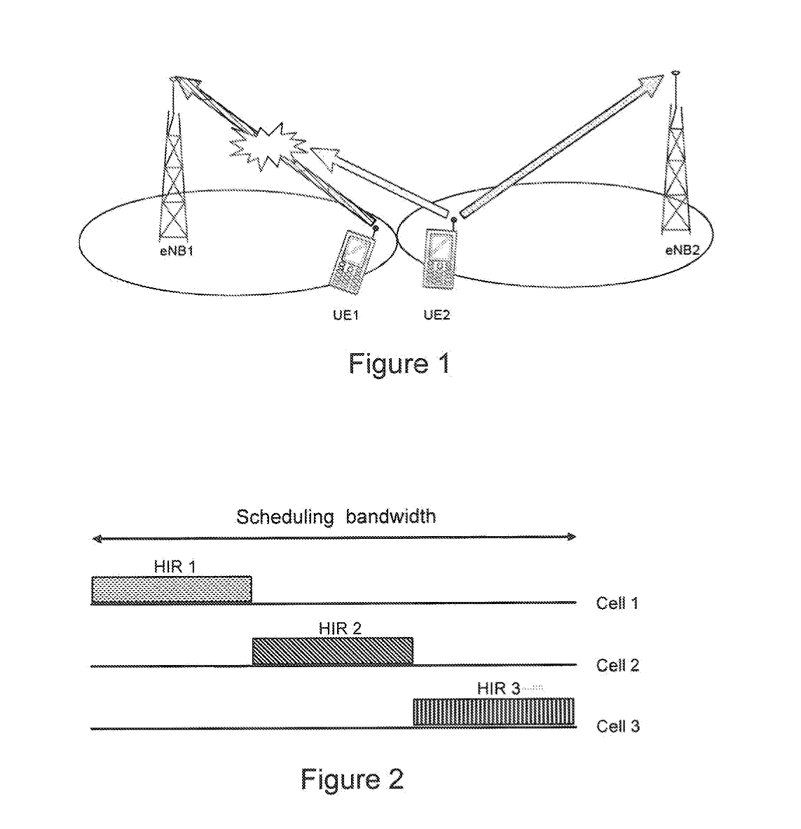

The technology described above provides multiple advantages. For example, the technology dynamically identities which cells should coordinate with each other with regard to likely inter-cell interference. This selectivity reduces the amount of inter-cell signaling and reduces the number of cells that need to take some type of ameliorative action. In turn, the chances of having a “ripple effect” in the system where all or a large number of cells send inter-cell information to each other, forcing them all to take unnecessary processing and possibly unnecessary ameliorative action. Another advantage is the technology permits weighting of an existing HII measure from a serving cell to several neighbor cells and to communicate this weighting in a way that is compatible with current 3GPP standards. The technology avoids the need for manual planning for high interference regions (HIRs) like that shown in FIG. 1 by dynamically selecting the FUR via coordination between different cells, e.g., by choosing HIR with a lowest sum weight, etc. In other words, not all geographically neighboring cells will uplink interfere with each other. When UEs change location and their likely interference with neighbor cells changes, these changes are dynamically and easily taken into account. The technology may also be implemented in a distributed way so that a centralized or master node is not required.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology described here, for it to be encompassed by the present claims. No claim is intended to invoke paragraph 6 of 35 USC §112 unless the words “means for” or “step for” are used. Furthermore, no embodiment, feature, component, or step in this specification is intended to be dedicated to the public regardless of whether the embodiment, feature, component, or step is recited in the claims.

1-29. (canceled)

30. A network node for interference coordination in a wireless communications network, the network node operative to communicate with user equipment (UE) in a cell served by the network node, the network node comprising:
a communications circuit configured to receive measurement reports from scheduled UEs;
a determination circuit operatively connected to the communications circuit and configured to:
determine, based on the received measurement reports, a number of neighboring cells that scheduled future transmissions by the scheduled UEs are likely to interfere with;
determine an interference indicator for each of the number of neighboring cells likely to be interfered with;
wherein the communications circuit is configured to send the interference indicator to one or more neighbor network nodes serving one of the number of neighboring cells likely to be interfered with.

31. The network node of claim 30, wherein the interference indicator information includes an estimate associated with an amount or a degree of interference likely to be caused in the number of neighboring cells by the served UE scheduled future transmissions.

32. The network node of claim 31, wherein the communications circuit is configured such that the interference indicator information includes, or is sent along with, information for identifying physical resource blocks to be used by one or more of the scheduled UEs.

33. The network node of claim 31, wherein the determination circuit is configured to control the communications circuit to send the interference indicator only to a subset of the number of neighboring cells likely to be interfered with.

34. The network node of claim 31:
wherein the determination circuit is configured to compare the amount or the degree of interference likely to be caused in the number of neighboring cells by the scheduled transmissions to a threshold;
wherein the communications circuit is configured to not send the interference indicator to neighboring cells based on the comparison.

35. The network node of claim 30, wherein the determination circuit is configured to selectively weight the interference indicator differently for different ones of the neighbor cells.

36. The network node of claim 35, wherein the interference indicator is a standardized information element that conveys the same information to each one of the neighboring cells to which the communications circuit sends the interference indicator.

37. The network node of claim 36, wherein the determination circuit is configured to increase a weight associated with the standardized information element sent to one of the neighbor cells by repeating a cell identifier within that standardized information element.

38. The network node of claim 36, wherein the determination circuit is configured to increase a weight associated with the standardized information element for a neighbor cell by repeating the standardized information element sent to that neighbor cell.

39. The network node of claims 30, wherein the interference indicator is a bitmap.

40. The network node of claim 30, wherein measurement reports are based on one or more predetermined handover events.

41. The network node of claim 30, wherein the network node is a base station.

42. The network node of claim 30, wherein the communications circuit is configured to send one or more interference indicators in an inter-cell interference coordination message.

43. The network node of claim 30:
wherein the communications circuit is configured to receive an interference indicator from another network node;
wherein the determination circuit is configured to:
determine, based on the received interference indicator, an estimate of interference or an interference event likely to be experienced in the cell served by the network node as a result of scheduled future transmissions by UEs served by the another network node;
determine whether to account for the received interference indicator in scheduling resources for future communications.

44. The network node of claim 43, wherein the communications circuit is configured to schedule future communications to avoid or reduce the impact of likely uplink interference.

45. The network node of claim 43, wherein the communications circuit is configured to receive the interference indicator in an inter-cell interference coordination message.

46. A method for interference coordination in a wireless communications network including a network node communicating with user equipment (UE) in a cell served by the network node, the method comprising the network node:
receiving measurement reports from scheduled UEs;
determining, based on the measurement reports, a number of neighboring cells that scheduled future transmissions by the scheduled UEs are likely to interfere with;
determining an interference indicator for each of the number of neighboring cells likely to be interfered with;
sending the interference indicator to one or more neighbor network nodes serving one of the number of neighboring cells likely to be interfered with.

47. The method of claim 46, wherein the interference indicator includes an estimate associated with an amount or a degree of interference likely to be caused in the number of neighboring cells by the scheduled future transmissions.

48. The method of claim 47, wherein the interference indicator includes, or is sent along with, information for identifying physical resource blocks scheduled to be used by one or more of the scheduled UEs.

49. The method of claim 47:
wherein the interference indicator includes an estimate associated with the amount or the degree of interference likely to be caused in the number of neighboring cells;
wherein the method further comprises sending the interference indicator only to a subset of the number of neighboring cells likely to be interfered with.

50. The method of claim 46:
wherein the interference indicator includes an estimate associated with an amount or a degree of interference likely to be caused in the number of neighboring cells;
wherein the method further comprises:
comparing the amount or the degree of interference likely to be caused in the number of neighboring cells by the scheduled transmissions to a threshold;
not sending the interference indicator to one or more neighboring cells based on the comparing.

51. The method of claim 46, further comprising selectively weighting the interference indicator differently for different ones of the neighbor cells.

52. The method of claim 51, wherein the interference indicator is a standardized information element that conveys the same information to each one of the neighboring cells to which the interference indicator is sent.

53. The method of claim 52, further comprising increasing a weight associated with the standardized information element sent to one of the neighbor cells by repeating a cell identifier within that standardized information element.

54. The method claim 52, further comprising increasing the weight associated with the standardized information element for a neighbor cell by repeating the standardized information element sent to that neighbor cell.

55. The method of claim 46, wherein the interference indicator is a bitmap.

56. The method of claim 46:
wherein measurement reports are based on one or more handover events;
wherein the measurement reports are sent in an inter-cell interference coordination message.

57. The method of claim 46, further comprising:
receiving an interference indicator from another network node;
determining, based on the received interference indicator, an estimate of interference or an interference event likely to be experienced in the cell served by the network node as a result of scheduled future transmissions by UEs served by the another network node;
determining whether to account for the received interference indicator information in scheduling radio resources for future communications.

58. The method of claim 57, wherein the method further comprises, in response to the interference indicator indicating a level of likely uplink interference as a result of future scheduled transmissions by UEs served by the another network node, scheduling future communications to avoid or reduce an impact of the likely uplink interference.
